(19) United States
(12) Patent Application Publication
(10) Pub. No.: US 2009/0047391 A1
(43) Pub. Date: Feb. 19, 2009

(54) Method Of Preparing Dough Products

(76) Inventors: Peter Stolz, Koenigswinter (DE); Simon Christopher Huscroft, Voorschoten (NL); Neil Graham Hargreaves, Chester (GB); Udo Scharf, Weiler (DE); Kerstin Hahn-Schmidt, Diemen (NL); Mathieu Van Son, Nieuwegein (NL); Martijn Willem-Jan Noort, Hilversum (NL)

Correspondence Address: ABELMAN, FRAYNE & SCHWAB, 666 THIRD AVENUE, 10TH FLOOR, NEW YORK, NY, 10017, US

(21) Appl. No.: 11/547,206

(22) PCT Filed: Apr. 4, 2005
(86) PCT No.: PCT/NL2005/000243

§ 371 Date: Sep. 26, 2008

(30) Foreign Application Priority Data
Apr. 2, 2004 (EP) 04076056.3

(51) Int. Cl. A21D 13/00; A23L 1/035

(52) U.S. Cl. 426/94; 426/293

(57) ABSTRACT

The present relates to a method of preparing a dough product comprising: mixing flour, water and optionally other bakery ingredients to form a dough; and applying a coating composition directly to the outside surface of the dough at a stage of the dough manufacture when the dough is no longer subjected to kneading or lamination, said coating composition containing, calculated on dry matter, emulsifier in an amount of 10-100% and polysaccharide in an amount of 0-20%. The dough products obtained by the present method offer the advantage that they can be baked or fried to yield a product that will retain a crispy crust for a considerable period of time and even after reheating of the baked or fried product. Other aspects of the invention relate to dough products that can be obtained by the aforementioned method as well as to baked and fried products obtained by baking or flying such a dough product.

### TECHNICAL FIELD OF THE INVENTION

The present invention relates to a method of preparing a dough product. The dough products obtained by the present method offer the advantage that they can be baked to yield a product that will retain a crispy crust for a considerable period of time after baking and even after reheating of the baked product. Also when fried, the dough products according to the invention deliver these particular benefits.

Other aspects of the invention relate to dough products that can be obtained by the aforementioned method as well as to baked and fried products obtained by baking or frying such a dough product.

### BACKGROUND OF THE INVENTION

The manufacture of bakery products, such as bread, pastry and doughnuts, commences with the preparation of a dough. Often, the dough is proved before it is baked or fried to yield a product with a crispy crust and a soft interior. The crispy crust is an important quality parameter of these baked and fried products. If crispiness is lacking, consumers will perceive the product as not being fresh.

The crust of freshly baked or fried dough products will loose its crispy nature over time. As a result, product quality is perceived to decrease rapidly. Furthermore, such baked or fried products cannot be “refreshed” by reheating, particularly microwave reheating, as the crust properties will deteriorate as a result of reheating.

U.S. Pat. No. 6,265,005 describes a coating composition for food products, particularly fried food products, which provides enhanced crispiness and heat retention as well as uniformity in cooked colour. The batter-type coating composition contains from about 5% to about 95% by weight starch, from about 12% to 95% by weight gum acacia and typically from about 10% to about 60% water. The composition may further contain from about 0.1% to about 5% oil and from about 0.1% to about 5% emulsifier. Dough is nowhere mentioned in the US patent.

U.S. Pat. No. 5,989,603 describes a method of imparting a fried surface texture to a baked dough product, comprising coating a shaped, unbaked dough product with a glaze comprising an oil-in-water emulsion containing about 20-90% water, about 10-80% oil, about 0.1-15% edible hydrophilic colloid and baking said unbaked dough product. Typically, the glaze is applied in an amount of about 3-10% by weight of the dough product. In column 5 lines 56 to 61, it is stated that an emulsifier can be included in the glaze in an amount effective in promoting the formation of an oil-in-water emulsion, preferably in an amount from about 0.1-2% by weight of the dough product. Clearly, the latter percentages have been expressed erroneously by weight of the dough product instead of the glaze.

U.S. Pat. No. 5,458,898 describes a microwave composition for coating a food product so as to promote surface heating and/or browning of the coated food product when upon exposure to microwave energy. The coating composition contains 8-97% of an edible oil, 1-90% of a microwave absorbing emulsifier, 0.1-30% of microwave absorbing inorganic material and 2-90% of a polyhydric alcohol. Suitable microwave absorbing emulsifiers are PGE, sorbitan monoesters, acetylated monoglycerides, sodium stearoyl-2-actylate (presumably lactylate is meant?) and mixtures thereof. Example 3 describes the application of a coating composition containing 10 wt. % mono/di's to the top of a refrigerated biscuit dough disk.

U.S. Pat. No. 4,487,786 describes a method of enrobing a frozen food product with a slurry comprising a starch material by applying said slurry to the outer surface of the frozen product. After the starch slurry has been applied, the food product is frozen and then coated with a high melting point lipid. Example 1 describes a process in which a filled dough is coated with a flour based slurry and is subsequently sprayed with a lipid solution of 25% acetylated monoglycerides and 75% palm lipid.

### SUMMARY OF THE INVENTION

The inventors have found unexpectedly that the crispy crust of baked and fried dough products will retain its crispy character for a prolonged period of time if emulsifier is applied to the outside of the dough product prior to baking, part-baking or frying. The inventors have also observed that these fully baked or fried products can suitably be reheated, e.g. in a microwave, to restore the original freshly baked or fried characteristics without such reheating causing a loss of crust crispiness and/or the development of a ‘tough’ texture.

Although the inventors do not wish to be bound by theory, it is believed that the emulsifier somehow slows down the migration of water from the interior of the baked or fried product to the crust and/or inhibits the uptake of water by the crust from the surrounding atmosphere. The inventors have observed that the application of emulsifier to the outside of the dough has an impact on the crust structure that could cause reduced water migration and/or uptake.

In accordance with the present invention the emulsifier is applied to the dough product in the form of a coating composition containing, calculated on dry matter, emulsifier in an amount of 10-100% and polysaccharide in an amount of 0-20%. Unlike the batter-type coating compositions described in the aforementioned prior art documents, which after baking or frying leave a solid crust of hydrocolloid material onto the outside of the baked or fried dough product, the present coating composition merely modifies the natural crust properties of the baked or fried product without superimposing a hydrocolloid based crunchy layer. In other words, the present coating composition reinforces and stabilises the natural crust of the baked or fried product instead of providing an extra crunchy layer.

### DETAILED DESCRIPTION OF THE INVENTION

Thus, one aspect of the invention relates to a method of preparing a dough product comprising:

a. mixing flour, water and optionally other bakery ingredients to form a dough; and
b. applying a coating composition directly to the outside surface of the dough at a stage of the dough manufacture when the dough is no longer subjected to kneading or lamination, said coating composition containing, calculated on dry matter, emulsifier in an amount of 10-100% and polysaccharide in an amount of 0-20%.

It is an essential element of the present invention that the coating composition is applied to the outside surface of the dough product before baking, part baking or frying. Here the terminology “part baking” refers to the incomplete baking of a dough product resulting in a product that needs to be subjected to another baking step to yield a fully baked product. Typically, part baked products do not exhibit the strong crispy crust that is typical of fully baked products.

It is well known in the art to apply emulsifier containing compositions such as shortenings in the manufacture of dough products. For instance, in the preparation of laminated doughs a dough sheet is prepared onto which a shortening is sprinkled or otherwise applied. Next the sheet is folded and the shortening layer is essentially sandwiched between two dough layers. The folded dough is then rolled to reduce thickness and folded again and rerolled. This folding and rolling may be repeated several times. In accordance with the present invention the coating composition is applied to the outside surface of the dough at a stage of the dough manufacture when the dough is no longer subjected to lamination. Thus, the present invention does not encompass the use of the coating composition as a laminating agent.

It is an essential element of the present invention that the coating composition is applied directly to the outside surface of the dough. Thus, the present method does not encompass treatment of the raw dough surface with another material prior to application of the coating composition, especially not with a material such as batter or crumb.

In the prior art it has been suggested to apply so called browning compositions to the surface of dough products in order to achieve additional surface browning, notably during microwave heating. Browning compositions that will darken during heating usually contain reducing sugars and proteinacous components that will react to form so called Maillard reaction products. The present method preferably does not employ such a browning composition. Accordingly, in a preferred embodiment the coating composition as such is non-browning during baking or frying conditions. More preferably, the coating composition as such is also non-browning during microwave reheating conditions.

The coating composition employed in the present method may contain water. Preferably, the coating composition contains not more than 0-3% water by weight of dry matter as higher water levels can have an adverse effect on crust crispiness. More preferably, the coating composition contains 0-2% water, most preferably it contains 0-1 wt. % water by weight of dry matter.

The present coating composition may contain small amounts of the polyhydric alcohols described in U.S. Pat. No. 5,458,898. Preferably the coating composition contains 0-1.9%, more preferably 0-1% and most preferably 0-0.5% of these polyhydric alcohols by weight of dry matter. In another preferred embodiment, the present composition contains 0-1.9, more preferably 0-1%, most preferably 0-0.5% alcohols, including polyhydric alcohols. Most preferably, the present composition contains no alcohols.

Besides liquid hydrophilic components such as water and polyhydric alcohols, the coating composition may contain other hydrophilic components such as carbohydrates, salts, proteins and minerals. Preferably, the coating composition contains, calculated on dry matter, less than 1%, preferably less than 0.1% hydrophilic components selected from the group consisting of carbohydrates, salts, proteins and minerals.

According to a particularly preferred embodiment, the coating composition employed in the present method is a single phase lipophilic liquid. The application of such a single phase lipophilic liquid offers the advantage that the coating composition can be applied as a transparent liquid, that no solid deposits are formed on the dough surface and, most importantly, that a nice crispy crust can be obtained that retains its crispiness during reheating.

The present method is particularly suitable for treating dough product selected from the group consisting of bread dough, pastry dough, snack dough and raw doughnut.

In a preferred embodiment of the invention the emulsifier is selected from the group consisting of: monoglycerides; diglycerides; esters of these glycerides and food acids; and combinations thereof. It is noted that the term “food acids” does not encompass fatty acids, i.e. alkanoic or alkenoic acids with 6 or more carbon atoms.

Particularly good results in terms of crust stability can be obtained if the emulsifier is selected from the group consisting of: monoglycerides; esters of monoglycerides and food acids; and combinations thereof. Examples of such food acids include acetic acid; propionic acid; butyric acid; citric acid; lactic acid; tartaric acid; diacetyl tartaric acid; maleic acid; malic acid; succinic acid; and phosphoric acid. The term “esters of monoglycerides and food acids” encompasses both mono- and diesters. As regards the diesters, the food acid residues within the diester my be identical or different.

According to a particularly preferred embodiment, the emulsifier employed in accordance with the present invention is a monoglyceride; an ester of monoglyceride and one or more food acids selected from the group consisting of acetic acid, propionic acid and butyric acid; and combinations thereof. Most preferably, the emulsifier employed is a monoglyceride, an ester of monoglyceride and acetic acid (acetoglyceride) or a combination thereof.

The emulsifier contained in the coating composition according to the present invention preferably is solid at 20° C. Even more preferably, the emulsifier is solid at 30° C. Particularly good results are obtained with the present method the emulsifier is applied to the outside surface of the dough in the form of the coating composition in an amount of at least 0.05 mg/cm². More preferably, the emulsifier is applied in an amount of at least 0.1 mg/cm², most preferably in an amount of at least 0.3 mg/cm². Usually, the emulsifier is applied in an amount not exceeding 60 mg/cm², preferably not exceeding 40 mg/cm², most preferably not exceeding 30 mg/cm².

In another preferred embodiment, the emulsifier is applied in an amount of at least 0.01%, even more preferably in an amount of at least 0.03% by weight of the dough. The applied amount preferably does not exceed 8%, more preferably it does not exceed 5%, most preferably it does not exceed 3% by weight of the dough.

The coating composition according to the present invention advantageously contains at least 20 wt. %, preferably at least 40 wt. % of emulsifier. In addition to emulsifier, the coating compositions may contain minor amounts of hydrophilic components such as polysaccharides, mono- and disaccharides, salt, proteins and minerals. Typically, the combined amount of these components in the coating composition will not exceed 30% by weight of dry matter. More preferably, said amount does not exceed 20%, most preferably it does not exceed 10% by weight of dry matter.

In a preferred embodiment of the invention the coating composition is a liquid or a free flowing powder. In a particularly preferred embodiment, the coating composition is applied in the form of a liquid. Here the term “liquid” also encompasses highly viscous liquids that offer the advantage that they will stick to the dough product. Furthermore, the term liquid includes emulsions and suspensions that exhibit fluid behaviour. The coating composition according to the present invention may suitably take the form of a single phase lipophilic liquid or a water containing emulsion. The bulk of the lipophilic liquid (e.g. at least 80 wt. %) may suitably consist of a combination of triglycerides and/or sucrose fatty acid polyesters and the present emulsifier. The water containing composition may be water-continuous or it may contain a continuous lipophilic phase. The lipophilic phase can have the same composition as the lipophilic liquid described herein before. The term “water containing emulsion” also encompasses aqueous systems in which the emulsifier is present as a micellar or lamellar phase

In the present method the coating composition may be applied by any technique that is suitable for depositing a relatively thin homogeneous layer onto the outside of the product. Suitable techniques, include spraying, brushing, pouring, dipping, sprinkling etc. Most preferably the coating composition is applied by spraying, dipping or brushing. It should be understood that the present invention also encompasses embodiments wherein the coating composition is applied indirectly, e.g. by spraying or brushing the composition onto the equipment that is used to shape or bake the dough.

The benefits of the present method may be realised in a variety of baked and fried dough products, including bread, pastry, doughnuts, fried snacks etc. In a particularly preferred embodiment the present method is used to prepare a bread dough product or a laminated dough product. Here the term “laminated dough product” refers to a dough product that has been obtained by repeated folding and rolling, with or without fat, of a dough sheet as evidenced by a stratified dough structure. Most preferably, the present method is used to prepare a bread dough product.

In the preparation of the present dough the flour and water may suitably be combined with a variety of bakery ingredients, e.g. yeast, fat, enzymes, eggs, sugar, salt and/or enzymes. Yeast is a particularly important ingredient that is commonly used in dough products to create an open internal structure. To allow the yeast to deliver this functionality, the dough is allowed to rest or prove for at least a few minutes before the dough is (part) baked or frozen.

The dough product according to the invention is suitably manufactured by means of a method that employs the step of proving the dough. The coating composition may suitably be applied prior to or after such proving step. Most preferably, the coating composition is applied after proving so as to ensure that the coating compositions is evenly distributed across the dough surface prior to baking or frying. The term “proving” as used herein refers to a dough treatment that allows the yeast in the dough to exert its action under optimised conditions. Typically, proving involves placing the dough into a proving cabinet in which an elevated temperature and controlled humidity are maintained.

The inventors have found that the crust quality of the baked product may be further improved by applying the coating composition to the outside surface of the dough product in combination with one or more components selected from the group consisting of fat, cystein, casein and organic acids; cystein and casein being most preferred. In a particularly preferred embodiment the latter one or more components are incorporated into the present coating composition.

The present invention offers an important unexpected benefit in that the favourable crust properties of the fully baked product are retained over a prolonged period of time even if the dough product or part baked product has been frozen and stored as such for a considerable period of time before baking or bake off. Consequently, in a highly preferred embodiment of the present method, the dough product or part baked dough product is frozen and stored in frozen form for at least 1 day, preferably at least 3 days, following application of the coating composition. to the dough product or following part baking of the dough product.

Another aspect of the invention relates to a dough product or part baked dough product carrying a deposit of emulsifier on the outside in an amount of at least 0.05 mg of emulsifier per cm² of surface area, said deposit covering at least 30 wt. % of the outside surface of the dough product. It should be noted that the emulsifier deposit does not need to be evident on the complete outside surface of the present (part baked) dough product. Typically, at least 30%, preferably at least 50% and most preferably at least 80% of the outside surface of the present dough product or part baked dough product will by covered by the emulsifier deposit. In a particular preferred embodiment, the deposit is present on the product in an amount of at least 0.1 mg, more preferably in an amount of 0.3 mg of emulsifier per cm² of surface area.

In a particular preferred embodiment the present dough product or part baked dough product is frozen, preferably deep frozen. The frozen product is suitably packaged in a material that carries instructions as to how to bake, bake off or fry the product.

Yet another aspect of the invention relates to a method of preparing a baked product from a dough, said method comprising baking a dough product obtained by a method as defined herein before or by baking a dough product or part baked dough product as defined above. Typically, the baking process involves exposure of the dough or part baked dough to temperatures in excess of 140° C. for at least 2 minutes.

The invention also provides a method of preparing a fried product from a dough, said method comprising frying a dough product obtained by a method as defined herein before or by frying a dough product as defined above. Frying usually involves at least partial immersion of the dough product into oil or fat that has been preheated to a temperature of at least 170° C.

The advantages of the invention are particularly evident if the baked or fried product so obtained is characterised by a crust with a moisture content of less than 25 wt. %, preferably of less than 20 wt. %, even more preferably of less than 16 wt. %. The product obtained after baking or frying the present dough product or after baking off the part baked dough product retains a crispy crust even when stored for several days. In contrast, baked or fried dough products or baked off products that are comparable to the present products, but which do not contain the an emulsifier deposit on the product surface, exhibit considerable crust softening during storage under comparable conditions.

A further aspect of the invention concerns a method of reheating a baked or fried product, said method comprising reheating a baked or fried product obtained from a method as defined above, preferably by microwave reheating. Surprisingly, it was found that the product obtained after baking or frying can be reheated by microwave without destroying the crispy nature of the crust. Furthermore, and even more surprisingly, it was found that in these baked or fried products, once they have lost most of their original crispiness, at least some of this crispiness will be restored during microwave reheating. In contrast, the crust of conventional fully baked or fried dough products will rapidly loose its crispiness during microwave reheating and develop a tough texture. Hence, microwave reheating is not an option for refreshing these conventional baked or fried products and a conventional oven must be used to achieve this. As will be evident, microwave reheating offers the advantage that it is fast and convenient, but also, and more importantly, that it does not result in a rapid drying out of the product. Thus, the present invention provides a method of refreshing baked or fried dough products by microwave reheating that yields reheated products that are essentially indistinguishable from freshly baked or freshly fried products.

Another aspect of the invention relates to the use of an emulsifier for improving the crispiness of a microwave reheated baked or fried dough product, said use comprising applying the emulsifier directly to the outside surface of the dough product prior to baking or frying. In accordance with a particularly preferred embodiment, the emulsifier is applied in the form of a coating composition containing 0-1.9% of a polyhydric alcohol by weight of dry matter. In accordance with another preferred embodiment, the emulsifier is applied in the form of a single phase lipophilic liquid.

The invention is further illustrated by the following examples:

### EXAMPLES

### Example 1

A conventional bread dough was prepared by combining the dry ingredients, including flour, yeast, sugar and salt, with water. The resulting dough was divided into pieces of about 35 grams. These pieces are shaped into squares of 7×7 cm.

The dough pieces thus obtained were randomly divided across three groups A, B and C. The outside of the dough pieces belonging to groups B and C was treated with emulsifier, whereas group A served as a control. The emulsifier containing coating compositions were applied by means of a brush.

A coating composition consisting of acetoglyceride (Bene fat ex Danisco) that had previously been molten by heating to 80° C. was applied evenly to the outside surface of the dough pieces of group B in an amount of approximately 1.0 g per piece, which amount equals about 20 mg/cm². Similarly, a coating composition consisting of glycerolmonostearate (type HV 40 ex Danisco) that had previously been molten by heating it to 80° C. was applied to the dough pieces of group C in an amount of approximately 1.2 g per piece, which amount equals about 25 mg/cm².

The coated dough pieces were proofed during 90 minutes at 30° C. at 85% relative humidity.

After proofing all the dough pieces were placed together into an oven that had been preheated to about 215° C. and were baked therein for about 20 minutes. The baked bread rolls so obtained exhibited a total weight of about 25 grams and a total surface area of approximately 49 cm². The crust represented about 3 grams of the bread roll.

The bread rolls were evaluated by a trained sensory panel after they had been stored at 20° C. for 1, 2, 4 and 24 hours after baking. The results of the evaluation are presented the following table:

| | | |
|---|---|---|
| After 1 hour | A (Control) | Soft, slightly tough, no crisp |
| | | or crunch, slices well with knife |
| | B (Acetoglyceride) | Slightly crisp, breaks up on bite, |
| | | breaks up when slicing with knife |
| | C(Glycerol | Crisp, snap, sharp in mouth, |
| | monostearate) | almost crunchy |
| After 2 hours | A (Control) | Soft, bendy, not dry or crisp, |
| | | slightly tough, not breaking on |
| | | slicing with knife |
| | B (Acetoglyceride) | Soft, easily broken up in mouth, |
| | | no sharp edges in mouth, slight |
| | | breakup on slicing with knife |
| | C(Glycerol | Crisp bite, crispy in mouth, |
| | monostearate) | breaks on slicing with knife |
| After 4 hours | A (Control) | Slightly tough, soft, bendy, not |
| | | crisp, slices well |
| | B (Acetoglyceride) | Soft, short bite, almost |
| | | dissolves in mouth |
| | C(Glycerol | Dry, crisp, sharp edges (snap), |
| | monostearate) | brittle, easily dissolves in |
| | | mouth, breaks up on slicing |
| After 24 hours | A (Control) | Soft, tough, slight chew, not |
| | | crispy or dry |
| | B (Acetoglyceride) | Soft, dissolves easily in the |
| | | mouth, slices well |
| | C(Glycerol | Tough, soft, slight chew, not |
| | monostearate) | dry or damp, sliced well |

These results show that the application of an emulsifier containing coating composition to the outside surface of the dough pieces yields bread rolls with a crust that retains crispiness and associated features for a longer period of time than untreated rolls.

The crispiness of the rolls was also evaluated by a trained sensory panel 24 hours after ambient storage following microwave reheating of 4 rolls in a 1100 W microwave oven for 20 seconds. In addition, the water activity of the crust was determined. Before microwave reheating all the rolls had completely lost their crispy crust characteristics. The results obtained are microwave reheating are presented in the following table:

| | 20 second microwave reheat (1100 watt) | |
|---|---|---|
| Group | Crust properties | A_{w} crust |
| A (Control) | Very tough & dry | 0.82 |
| B (Acetoglyceride) | Crumbly & crisp sensation | 0.78 |
| C (Glycerolmonostearate) | Crumbly not tough | 0.76 |

* Before microwave reheating, the water activity of the crust was similar (about 0.87) across the three groups.

These results show that the application of an emulsifier containing coating composition to the outside surface of the dough pieces yields bread rolls that can be reheated in a microwave to obtain rolls that, unlike those obtained from untreated dough pieces, do not exhibit a very tough and dry crust.

1. A method of preparing a dough product comprising:
a. mixing flour, water and optionally other bakery ingredients to form a dough; and
b. applying a coating composition directly to the outside surface of the dough at a stage of the dough manufacture when the dough is no longer subjected to kneading or lamination, said coating composition containing, calculated on dry matter:
emulsifier in an amount of 10-100 wt. %;
polysaccharide in an amount of 0-20 wt. %;
water in an amount of 0-3 wt. %;
hydrophilic components selected from the group consisting of carbohydrates, salts, proteins and minerals in an amount of less than 1 wt. %; and
polyhydric alcohol in an amount of 0-1.9 wt. %.

2. Method according to claim 1, wherein the coating composition as such is non-browning during baking or frying conditions.

3. Method according to claim 1, wherein the coating composition contains 0-3% water by weight of dry matter.

4. Method according to claim 1, wherein the coating composition contains, calculated on dry matter less than 0.1% hydrophilic components selected from the group consisting of carbohydrates, salts, proteins and minerals.

5. Method according to claim 1, wherein the coating composition contains 0-1% of polyhydric alcohol by weight of dry matter.

6. Method according to claim 1, wherein the coating composition is applied as a single phase lipophilic liquid.

7. Method according to claim 1, wherein the dough product is selected from the group consisting of bread dough, pastry dough, snack dough and raw doughnut.

8. Method according to claim 1, wherein the emulsifier is selected from the group consisting of: monoglycerides; diglycerides; esters of these glycerides and food acids; and combinations thereof.

9. Method according to claim 8, wherein the emulsifier is selected from the group consisting of: monoglycerides; esters of monoglycerides and food acids; and combinations thereof.

10. Method according to claim 8, wherein the food acids are selected from the group consisting of acetic acid; propionic acid; butyric acid; citric acid; lactic acid; tartaric acid; diacetyl tartaric acid; maleic acid; malic acid; succinic acid; and phosphoric acid.

11. Method according to claim 1, wherein the emulsifier is applied to the outside surface of the dough product in an amount of at least 0.05 mg/cm².

12. Method according to claim 1, wherein the coating composition contains at least 20 wt % of the emulsifier.

13. A dough product carrying a deposit of emulsifier on the outside in an amount of at least 0.05 mg of emulsifier per cm² of surface area, said deposit covering at least 30 wt. % of the outside surface of the dough product, said dough product being obtainable by a method according to claim 1.

14. A method of preparing a baked product from a dough or a part baked dough, said method comprising baking a dough product obtained by a method comprising:
a. mixing flour, water and optionally other bakery ingredients to form a dough; and
b. applying a coating composition directly to the outside surface of the dough at a stage of the dough manufacture when the dough is no longer subjected to kneading or lamination, said coating composition containing, calculated on dry matter, emulsifier in an amount of 10-100%, and polysaccharide in an amount of 0-20%; and water in an amount of 0-3 wt. %; said emulsifier being selected from the group consisting of: monoglycerides; diglycerides; esters of these glycerides and food acids; and combinations thereof.

15. A method of preparing a fried product from a dough, said method comprising frying a dough product obtained by a method comprising:
a. mixing flour, water and optionally other bakery ingredients to form a dough; and
b. applying a coating composition directly to the outside surface of the dough at a stage of the dough manufacture when the dough is no longer subjected to kneading or lamination, said coating composition containing, calculated on dry matter, emulsifier in an amount of 10-100% and polysaccharide in an amount of 0-20%.

16. (canceled)

17. (canceled)

18. A method according to claim 2, wherein the coating composition as such is non-browning during baking and frying conditions.

19. A method according to claim 9, wherein the foods acids are selected from the group consisting of acetic acid, propionic acid, butyric acid, citric acid, lactic acid, tartaric acid, diacetyl tartaric acid, maleic acid, malic acid, succinic acid and phosphoric acid.

20. A method according to claim 1, wherein the coating composition contains at least 40 wt % of the emulsifier.
